(19) United States
(12) Patent Application Publication
(10) Pub. No.: US 2004/0211525 A1
(43) Pub. Date: Oct. 28, 2004

(54) Tape machine and wiper

(76) Inventor: Charles R.J. Boutin, Ottawa (CA)

Correspondence Address: CHARLES R.J. BOUTIN, UNIT 203, 215 Wurtemburg St., OTTAWA, ON, K1N 8T1, CA

(21) Appl. No.: 10/729,290

(22) Filed: Dec. 8, 2003

(30) Foreign Application Priority Data
Apr. 28, 2003 (CA) 2,426,789

(51) Int. Cl. B44C 7/04; B32B 31/00

(52) U.S. Cl. 156/577; 156/574; 156/579

(57) ABSTRACT

In a tool for applying wet tape (with compound) onto drywall seams, it is known that several types of apparatus can do so. In this invention, interchangeable scraper and wheel mounted on leaver like manual mechanism, allow applicator to wipe excess compound under wet tape as it is put on.

This invention relates to improvements in taping machines for wallboard, gypsum board, sheet rock, dry wall, or the like, and is arranged to supply adhesive coated tape over and wipe the joints of the wallboard or the like.

The joints between abutting panels of various types of wall covering sheet material is conventionally covered with a paper tape. Such tape is coated with an adhesive, usually a plaster or packing material and either of these serves as an adhesive for securing the tape to the joints. Additional adhesive material may subsequently be added to provide sufficient material to present a smooth surface over the joint.

Apparatus for applying tape to wall boards on a production basis are well known in the art. However, the known taping machines are rather elaborate affairs, being very expensive to manufacture and mostly are rented to the user, rather than a direct sale. One avail-able mechanical taping machine includes a tape holder which applies the tape to the wall and a separate reservoir and pump which pumps mud through a hose to the applicator. Such an apparatus, and other commercially available units, are useful for large contractors, but are not economically feasible for smaller contractors where taping constitutes a rather small portion of their total business. Other disadvantages of current taping machines include cleaning problems, which prevent a thorough daily cleaning of the unit, difficult feeding of adhesive mud to the mud reservoir, excessive weight of the unit, etc.

It is, therefore, among the objects and advantages of the present invention to provide a taping machine for paper tape which is simple to use and is sufficiently lightweight for continuous use during a full workday.

Another object of the present invention is to provide a taping machine of simple design which is easily cleaned of mud, adhesive or the like.

Another object of the invention is to provide a reservoir for adhesive which is arranged to maintain adhesive in contact with tape passing through the reservoir.

Yet another object of the invention is to provide a taping machine having an accurate control on the quantity of adhesive applied to the tape.

A still further object of the invention is to provide a taping machine having a single lever control for a cutting mechanism and a tape holding mechanism.

An additional object of the invention is to provide a taping machine which is easily handled by a single workman and is easily manipulated throughout a taping operation.

It allows to wipe said tape as it is applied with added scraped.

These and other objects and advantages of the invention may be readily ascertained by referring to the following description and appended illustrations in which:

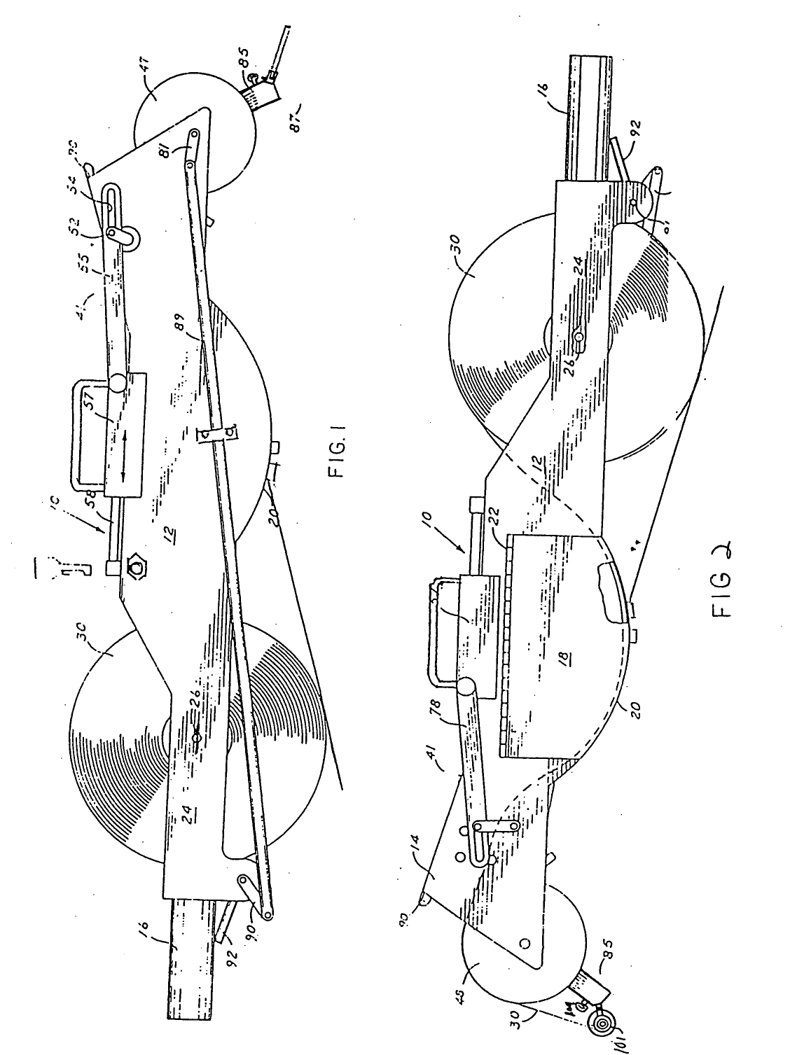

FIG. 1 is side elevation views of the right side of a tape machine with flexible and interchangeable redesigned attached scraper added to arm according to the invention;

FIG. 2 is a side elevation view of the left side of the taping machine with interchangeable wheel according to the invention;

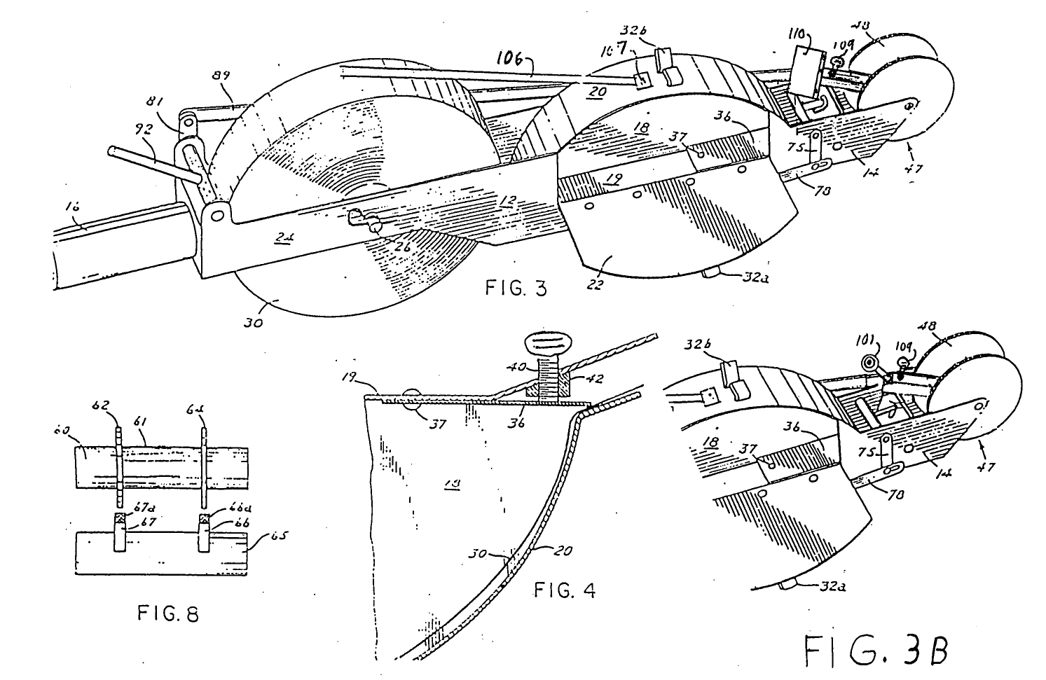

FIG. 3 and FIG. 3B are a perspective views of a taping machine according to the invention with reservoir open for filling with an adhesive and both interchangeable scraper and wheel;

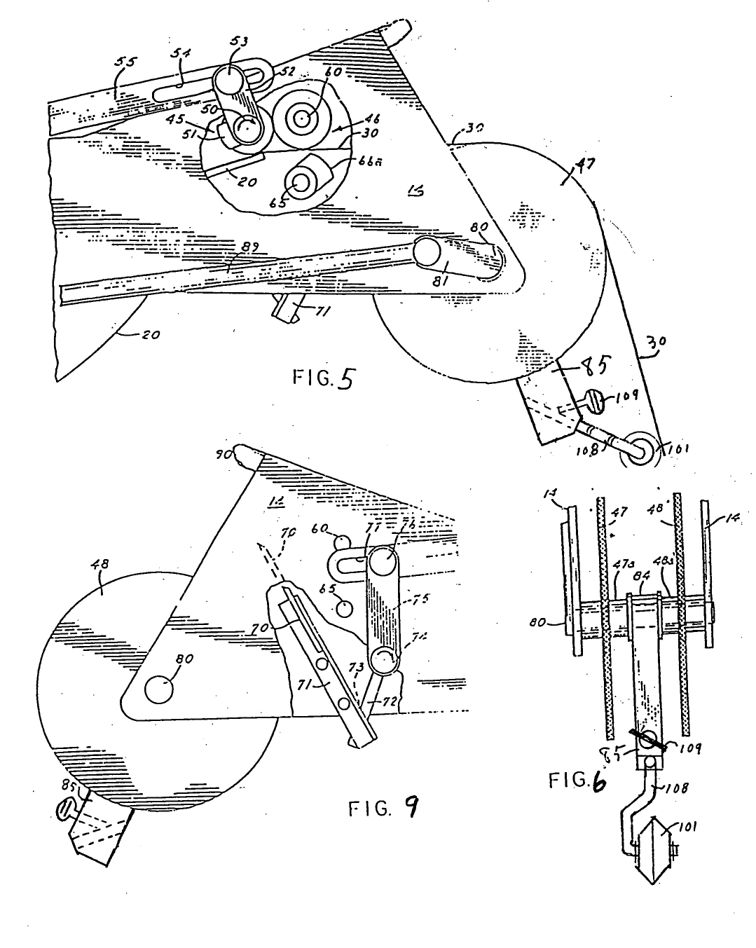

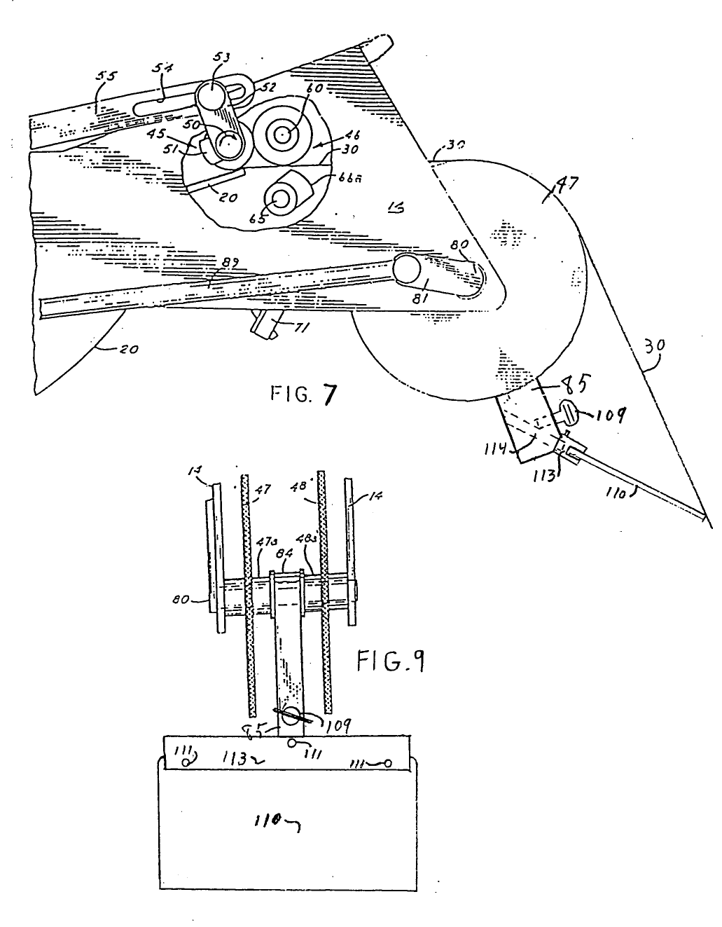

FIG. 4 is enlarged detail, cross sectional views of an adhesive gate valve of the taping machine according to the invention;

FIG. 5 is enlarged detail views, partly broken away, of a tape holding mechanism including right side of partial wiping wheel;

FIG. 6 is enlarged detail views, partly broken away, of mechanism according to the invention and front side of said wheel;

FIG. 7 is front elevation views of tape applying wheels of the tape machine and scraper of the invention showing modifications and;

FIG. 8 is a front elevation detail of loading mechanism and reversed holding mechanism of the cam according to the invention.

FIG. 9 is enlarge detail views, partly broken away, of cutting mechanism according to the invention and side view of empty arm which would allow either, scraper or folding wheel(not included).

In the form of a tape applying apparatus selected for illustration, a taping unit, shown in general by numeral 10, includes an elongated body 12 terminating in a bifurcated end 14 at one end and a manipulating handle mechanism 16 at the opposite end.

Included on the frame 12 is a mud reservoir 12 having an accurate wall 20 and a cover 22, The mud reservoir is mounted inter-mediate the ends of the device, providing a slit entrance for tape and a slit exit for tape. Adjacent to the mud reservoir is a bifurcated section 24 having a shaft 26 extending through both sides of the bifurcated section on holding a roll of paper tape 30. The free end of the tape 30 passes into the reservoir 18, normally conforming along the accurate wall 20, and out though bifurcated end 14 for application to the wall, as explained below. The hinged cover 22 is provided with a latch mechanism closing the reservoir, and a luggage type lock 32, and 32b is satisfactory. Various latch mechanisms may be used.

A gate valve mechanism is arranged in the reservoir at the outlet end for the tape passing through the reservoir, and it includes gate valve 36 (FIGS. 3 and 4) secured by fastening means 37 to the upper wall 19 of the reservoir 18 and extending over the outlet to the reservoir. A thumb-screw 41 for manipulation is threaded through wall 19 having a threaded reinforcing member 42 thereon. The bolt variably bears against the gate valve 36. This provides an adjustment of the distance between the gate valve 36 and the wall 20 as the tape 30 passes through the reservoir 18 and over the outlet past the gate valve. Therefore, the quantity of adhesive on the tape may be controlled.

The tape leaving the reservoir passes under a tape locking mechanism, shown in general by numeral 45, FIG. 5, between a reverse locking set shown in general by numeral 46 and over applicator rolls 47 and 48. The locking mechanism includes a shaft 50 having an attached eccentric 51 arranged to press the tape 30 against the wall 20 when the shaft 50 is rotated in a counter clockwise rotation. An arm 52 is secured to the shaft 50, and the arm 52 is pinned by a pin 53 into a slot 54 in a push-pull rod 55. The rod 55 is pivotally mounted on a 4ide bar 57 (FIG. 1) which is arranged to slide on track 58. A tape locking cam 51 mounted on shaft 50 is arranged to lock the tape between it and wall 20 before movement of the cutting knife in cutting the tape.

When the slide 57 is moved to a full forward position the arm or crank 52 is pulled forwardly in a clockwise rotation around the shaft 50 raising the cam 51 from the wall 20 and releasing the tape 30 for freely passing there between. When the arm is moved backwardly to release the pressure from the back of the slot on the pin, the springs rotates the shaft counter clockwise so that the eccentric 51 bears against the wall 20 and the tape there between. The elongated slot gives a lost motion to the connecting arm 55 and permits it to release only when the slide 57 is moved to the full forward position.

In intermediate positions the tape is locked between the eccentric 51 and the wall 20. To prevent the tape from hacking up into the unit, a one-way gate is provided, as shown in FIGS. 5 and 8.

A shaft 60 mounted between the two walls of the bifurcated end is arranged with a free running roller 61 having two discs 62 and 64, thereon. The roller 60 is arranged for free rotation in a counter clockwise direction. A second shaft 65 (mounted below shaft 60) is provided with a pair of spaced apart eccentrics 66 and 67 which are secured to and rotate with the shaft 65.

The edge 66a of eccentric 66 is smooth and the edge 67a of the eccentric 67 is likewise smooth: The shaft 65 is spring loaded by means of a helical spring, not shown biasing it in a counter clockwise direction, so I that the tape 30 between the roller discs and the eccentrics may freely pass outwardly. On reverse movement of the tape 30, the eccentrics press against the discs locking the tape from a reverse motion. This arrangement provides means for preventing reverse rolling of 2 the tape roll 30. The tape cutter, FIG. 6, includes a sliding knife 70 mounted in a slide guide 71 which is mounted between walls of the bifurcated end 14. The knife is arranged to move from a retracted position, shown in full lines 70, 2 to an extended position, shown in dash lines. Movement of the knife is achieved by means of an arm 72 mounted in a slot 73 in the knife. The arm 72 is affixed to a shaft 74 and pivots therewith. The shaft has a lever 1 arm 75 attached thereto so that movement of the arm.

75 rotates the shaft 74 moving the arm 72 upwardly and downwardly and extending or retracting the knife blade 70. The arm 75 is pinned by means of a pin 76 into a slot 77 in push-pull arm 78 which is attached to the slide 57. The slot provides a lost motion for the arm 78 whereby the slide may be moved forward, to release the lock of the cam 51 on the paper as explained above without pressing the arm 72 against the bottom of the slot 73 of the knife.

At the outer end of the end 14 is mounted a shaft 80 between the two walls. Attached to the shaft at one end, on the outside of the wall, is an arm 81 arranged for rotational movement therewith. Mounted on the shaft 80 are the two freely rotating wheels 47 and 48 each having hubs 47a and 48a for spacers and a ser-rated edge. The wheels are arranged to press the adhesive coated tape onto wallboard. Secured to the shaft for rotation therewith between the two wheels, is a hub 84 from which extends an arm 85, a bifurcated end 86 in arm 85 supports a rotatable wheel 101. The wheel 101, mounted on shaft 87a between the ends of bifurcated or scraper 110 end 86, is arranged to be moved into forward position to crease or smooth the tape coming over wheel 47-48, permitting it to be moved into a as it is being taped. Pivotally attached to the bell crank or arm 81 is push-pull rod 89 which is attached at its opposite end to a hell crank 90 secured to a shaft 91 (FIG. 2) mounted for rotation below the handle 16. Secured to the shaft 91 and arranged for rotation therewith is a manipulating handle 92. The lever system is arranged so that when the handle 92 is pivoted away from the handle 16 the creasing roller 97 is moved into a retract position. When the handle 92 is pulled into general contact with the handle 16, shown in FIG. 1, the roller 87 is extended. This permits the worker to use one hand to operate the creaser roller when desired. The roller is moved to extended position as shown in FIG. 1.

In this extended position the creaser or wiper creases the paper tape as or wipe it. It is moved onto the wall from the unit. A stationary knife 90 mounted above the wheels 47-48 between the walls of end 14 provides means for cutting tape apart from the blade 70.

For use of the unit, a roll of tape 30 is placed on the shaft 26 and the end of the tape is passed through the opening into the reservoir 18 and out between gate valve 36 and wall 20. The slide 57 is pushed fully forward so that tape may move freely between locks 45 and ˜. The tape is pulled through the one way gate 46 and passed over the rollers 47. The tape is moved to generally conform to the wall 20 and the reservoir 18 is filled with the adhesive. The cover for the reservoir is closed and locked and the machine is then ready for use. A sufficient amount of tape is pulled out through the unit so that tape coated with adhesive appears on the rollers. Note that the inside of the tape is coated with the adhesive and as it extends out over the rollers that is the side of the tape which contacts the wall. Thus the adhesive is on the tape side contacting the wall. The gate valve is adjusted for desired thickness of adhesive by rotating the thumb-screw 40. The unit is then ready for use. Tape with adhesive on the exposed surface is passed over the rollers 47 and 48 and placed on the wall at the bottom of a joint. The slide 57 is pushed full forward to release the lock on the tape, so that the taping may proceed. The unit is then moved upwardly while the wheels are in contact with the wall. The unit is moved up the wall along the joint to the ceiling. At the wall ceiling intersection, the slide 57 is pulled to the full reverse position, which locks the paper tape and extends the knife forwardly cutting the tape at the joint. The slide is moved full forward. Additional tape is then pulled out around the wheels 47 and 48 and the taping of a ceiling proceeds by forcing the tape against the ceiling with the wheels 47-48. The machine is moved across the joint on the ceiling to the other intersection of the ceiling with the wall. At this point the slide is again pulled to full reverse, cutting the tape. After which, the slide is moved to full forward position again releasing the tape for continued taping.

The action of the unit maintains a constant pressure of the tape against the supply of adhesive in the reservoir. This is completely across the width of the tape and for the length of the reservoir. This insures that the width of the tape is completely covered with the adhesive. As the quantity of adhesive reduces in the reservoir, the tape moves with it away from the wall 20 so as to maintain full contact between the adhesive and the tape for sufficiently coating the tape. This insures that it will adhere to the wall. As the quantity of adhesive reduces, the tape approaches the top wall 19 of the reservoir.

When an inside corner to be taped is encountered, the operator merely pulls a handle 92 against the main handle 16 extending the creasing roller 101. Tape is then passed over the rollers 47 and 48 which are moved into contact with the walls straddling the corner. In this position, the creasing roller 101 is in the corner and it creases the tape as it is applied to the wall. The creasing roller stretches the tape between the two rollers, and all three rollers jointly lay the tape on the wall tightly and neatly creased. When the intersection of ceiling and wall is met, the slide is pulled back moving the cutter into cutting position and cutting off the tape at the corner, as explained above.

By making the unit about 34 inches long, the average height worker is able to tape the walls and the ceiling without additional help from elevating devices such as saw horses, stilts or the like, and he may produce a good taping job with a minimum of work in the taping process. By adjusting the gate valve the correct amount of adhesive may be applied to the tape so that the tape will provide a smooth joint when applied to the wall. Further, no extraneous adhesive leaves the reservoir so that there is no dripping of adhesive on the floors of the building, and the clean up after taping is minimal. As no extraneous adhesive leaves the unit during the taping, there is essentially no clean up of the tape after it is applied to the wall. Additional adhesive may be applied to the tape after the cement in the adhesive has dried, by the usual adhesive trowel.

As shown in FIG. 1 left and right handles 102 and 103 are fastened to a slide bar 57. A female mud adaptor 104 fastened to the body 12 and a male mud pump adaptor 105 are adapted to be to be secured to pipe fittings or a mud pump (not shown)

A spring 106 fastened to the body 12 and a tape spring block 107 keep the roll of tape 30 from unwinding unnecessarily.

A creaser wheel 101 and arm 108 holding a creaser wheel to the arm 85 is preferably fastened by a screw 109. As shown in FIGS. 5 and 6 a scraper 110 of suitable material such as plastic is provided to scrape excess dry wall compound in one motion as it is applied from underneath the dry wall tape. The scraper 110 is fastened as by a screws 111 and 112 the scraper holder 113, and scraper rod 114 attach to scraper holder 113 by screw 111 at one end and tighten by thumbscrew 109 as implied in FIG. 7.

1. A manually operable tool for applying wet tape (with compound) to drywall and wiping it as it is applied.

2. A tool defined in claim 1, in which two interchangeable devices for wiping wet tape including: (A) A wide roller wheel partially wiping inside corners and (B) A flexible plastic, nylon, rubber or like scraper for wiping flat surfaces.

3. A tool defined in claim 1 and/or claim 2 in which said interchangeable wipers are attach to leaver like mechanism to apply required pressure to wipe wet tape.
